(19) United States
(12) Patent Application Publication
(10) Pub. No.: US 2026/0215472 A1
(43) Pub. Date: Jul. 30, 2026

(54) Coating to Reduce Oil Uptake in Fried Snacks

(71) Applicant: Frito-Lay North America, Inc., Plano, TX (US)

(72) Inventor: Sathya B. Kalambur, Plano, TX (US)

(21) Appl. No.: 19/144,820

(22) PCT Filed: Dec. 20, 2023
(86) PCT No.: PCT/US2023/085200

§ 371 Date: Jun. 30, 2025

Related U.S. Application Data
(60) Provisional application No. 63/479,036, filed on Jan. 9, 2023.

(51) Int. Cl. A23P 20/10; A23L 5/10; A23L 19/18; A23P 20/15

(52) U.S. Cl. CPC A23P 20/105; A23L 5/11; A23P 20/15; A23L 19/18; A23V 2002/00; A23V 2200/22; A23V 2250/606; A23V 2250/61

(57) ABSTRACT

A coating and methods of making the coating to reduce oil uptake when frying a plant-based substrate to form finished fried snack food products having reduced oil content.

This application claims priority to U.S. Application No. 63/479036 filed Jan. 9, 2023, the entire contents of which are incorporated herein by reference.

The present disclosure relates generally to coatings that can be applied to a plant-based substrate. More specifically, the present disclosure relates to methods of coating a plant-based substrate prior to frying to reduce the oil uptake during the frying process. Other aspects include fried snack products with reduced oil content.

### BACKGROUND

Conventional potato chip products are prepared by the basic steps of slicing peeled, raw potatoes, washing the slices with water to remove surface starch and frying the potato slices in hot oil until a moisture content of about 1% to 2% by weight is achieved. The fried slices are salted or seasoned and then packaged.

Raw potato slices normally have moisture contents from 75% to 85% by weight depending on the type of potato and the environmental growing conditions. When potato slices are fried in hot oil, the moisture present boils. This results in inter-cellular separation and the formation of pores and voids which allows oil to absorb into the potato slices resulting in a significant amount of oil present inside and on the surface of the resulting potato chip.

The oil content of potato chips is important for many reasons. Most important is its contribution to the overall organoleptic desirability of potato chips. Too high of an oil content may render the chips greasy or oily and hence, less desirable to consumers. On the other hand, it is possible to make chips so low in oil that they lack flavor and seem harsh in texture.

Numerous attempts have been made to reduce the oil content in potato chips. However, past attempts at producing lower oil content chips are either expensive or use technology that requires longer than desirable de-oiling dwell time.

Consequently, a need exists for a process that enables the production of a fried food product, such as a potato chip, that has lower levels of oil than a traditionally fried food product.

### SUMMARY

A fried-snack having a reduced oil content is described. Importantly, the fried-snack of the disclosure is not meant as a substitute for a potato-chip or tortilla chip; rather, it is envisioned to be a new fried-snack product.

The fried-snack includes a plant-based substrate and a shell that includes lower molecular weight carbohydrate polymers. The shell is formed from an applied coating that includes particular ingredients, e.g., lower molecular weight carbohydrate polymers applied in a manner that reduces the amount of oil uptake during frying; thus, reducing the oil content of the fried-snack.

### BRIEF DESCRIPTION OF THE DRAWINGS

The following description accompanies the drawing(s), all given by way of non-limiting examples that may be useful to understand how the described method and composition may be embodied.

FIG. 1 is a graph comparing the oil uptake of fried potato slices having a coating according to some of the disclosed aspects compared to fried potato slices having no coating (control).

### DETAILED DESCRIPTION

### Methods of Making a Fried-Snack

A method of making a fried-snack includes contacting a plant-based substrate with a coating to form a coated substrate. It is contemplated that the plant-based substrate may be processed prior to coating, for example, by peeling, slicing, and/or washing. Alternatively a fabricated chip whose structure has been set by intermediate processing before frying (e.g. toasting/baking in tortillas) can be coated. Thereafter, the coated substrate may be fried to produce the fried-snack. Without being limited by any particular theory, the described coatings may form a barrier that, when contacted by the frying oil creates a stable shell that prevents or inhibits oil uptake by the plant-based substrate during frying. In other words, the parameters of the oil frying alter the coating on the plant-based substrate to produce a shell. Seasoning may be added to the fried-snack.

The plant-based substrate may or may not be dehydrated prior to contacting with the coating. Additionally, the plant-based substrate may or may not be dehydrated after coating but before frying.

The plant-based substrate may comprise one or more of a fruit, vegetable, grain, nut, legume, or seed. For example, the plant-based substrate may be formed from natural or raw plant-based sources such as raw fruits or vegetables. The plant-based source may include one or more of corn, tomato, spinach, beetroot, potato, sweet potato, onion, garlic, legumes, and pulses. Other examples of a plant-based substrate include apples, beets, carrots, pumpkins, parsnips, taro root or yucca root vegetables.

The natural or raw plant-based sources may be in the form of whole or pieces of the fruits, vegetables, legumes, nuts, and seeds. Alternatively or additionally, the plant-based substrate may be formed from flours or flour-like materials derived from any one or more of the above-described plant-based sources (e.g., corn meal).

Typically, although not necessarily, when the plant-based substrate is a raw material it may not be dehydrated prior to contacting with the coating. In such instances, the plant-based substrate may have a moisture content between about 5 wt. % to about 90 wt. %.

The plant-based substrate includes an outer surface configured to receive a coating. In some instances, the plant-based substrate may be prepared or pre-conditioned prior to contacting the outer surface of the plant-based substrate with the coating. For example, the outer surface may be prepared by peeling off an outer layer, such as a skin, and/or by slicing. Further, the plant-based substrate may be washed prior to coating. Yet, alternatively, the outer surface may be prepared by texturing the outer surface, for example, by slicing or using a tool to scratch or form grooves into the outer surface of the plant-based substrate. The surface may also be prepared by performing an intermediate toasting or baking step such as in the process of making tortillas.

Subsequent to the optional preparation of the plant-based substrate, a coating is applied to the outer surface of the plant-based substrate. In one embodiment, the coating may comprise lower molecular weight carbohydrate polymers and water. In other embodiments, the coating may comprise lower molecular weight carbohydrate polymers and poly-dextrose. In still other embodiments, the coating may comprise poly-dextrose and water. In yet another embodiment, the coating may comprise lower molecular weight carbohydrate polymers, poly-dextrose, and water.

### Lower Molecular Weight Carbohydrate Polymers

The lower molecular weight carbohydrate polymers may range in length from 2 to 10 linked monosaccharides (also referred to as linked monomers) and may have a molecular weight of about 5000 g/mol. The lower molecular weight carbohydrate polymers are characterized by high solubility in water with at least 30% solubility at room temperature (i.e., about 20° C.). The length of the lower molecular weight carbohydrate polymers may be between 2 and 10, 2 and 9, 2 and 8, 2 and 7, 2 and 6, 2 and 5, 2 and 4, 2 and 3, 3 and 10, 3 and 9, 3 and 8, 3 and 7, 3 and 6, 3 and 5, 3 and 4, 4 and 10, 4 and 9, 4 and 8, 4 and 7, 4 and 6, 4 and 5, 5 and 10, 5 and 9, 5 and 8, 5 and 7, 5 and 6, 6 and 10, 6 and 9, 6 and 8, 6 and 7, 7 and 10, 7 and 9, 7 and 8, 8 and 10, 8 and 9, or 9 and 10 linked monomers. The coating may include lower molecular weight carbohydrate polymers having a length between 2 to 6 linked monomers or 2 to 5 linked monomers. The lower molecular weight polymers may have a length between 2 to 5 linked monomers with no lower molecular weight carbohydrate polymers having a length longer than 6 linked monomers or longer than 5 linked monomers. The lower molecular weight carbohydrate polymers present in the coating may be organized into distinct groups based on the number of linked monomers.

In some embodiments, the coating may contain one or more of group A, group B, or group C lower molecular weight carbohydrate polymers where group “A” refers to lower molecular weight carbohydrate polymers having 2 to 5 linked monomers, group “B” refers to lower molecular weight carbohydrate polymers having 6 to 7 linked monomers, and group “C” refers to lower molecular weight carbohydrate polymers having 8 to 10 linked monomers. In some embodiments, the coating contains group A and group B; group A and group C; or group B and group C. The coating may contain each of group A, group B, and group C. The lower molecular weight carbohydrate polymers in the coating may be comprised of about 10% to about 90% group A and about 10% to about 90% group B. Alternatively, the coating may contain a distribution of lower molecular weight carbohydrate polymers from about 10% to about 50% group A, about 10% to 50% group B, and about 10% to 50% group C. The lower molecular weight carbohydrate polymers may be comprised of about 30% group A, about 30% group B, and about 30% group C.

The coating may contain an amount of group A from about 10% to about 90%, about 10% to about 80%, about 10% to about 70%, about 10% to about 60%, about 10% to about 50%, about 10% to about 40%, about 10% to about 30%, about 10% to about 20%, about 20% to about 90%, about 20% to about 80%, about 20% to about 70%, about 20% to about 60%, about 20% to about 50%, about 20% to about 40%, about 20% to about 30%, about 30% to about 90%, about 30% to about 80%, about 30% to about 70%, about 30% to about 60%, about 30% to about 50%, about 30% to about 40%, about 40% to about 90%, about 40% to about 80%, about 40% to about 70%, about 40% to about 60%, about 40% to about 50%, about 50% to about 90%, about 50% to about 80% about 50% to about 70%, about 50% to about 60%, about 60% to about 90%, about 60% to about 80%, about 60% to about 70%, about 70% to about 90%, about 70% to about 80%, or about 80% to about 90%.

The coating may contain an amount of group B from about 10% to about 90%, about 10% to about 80%, about 10% to about 70%, about 10% to about 60%, about 10% to about 50%, about 10% to about 40%, about 10% to about 30%, about 10% to about 20%, about 20% to about 90%, about 20% to about 80%, about 20% to about 70%, about 20% to about 60%, about 20% to about 50%, about 20% to about 40%, about 20% to about 30%, about 30% to about 90%, about 30% to about 80%, about 30% to about 70%, about 30% to about 60%, about 30% to about 50%, about 30% to about 40%, about 40% to about 90%, about 40% to about 80%, about 40% to about 70%, about 40% to about 60%, about 40% to about 50%, about 50% to about 90%, about 50% to about 80% about 50% to about 70%, about 50% to about 60%, about 60% to about 90%, about 60% to about 80%, about 60% to about 70%, about 70% to about 90%, about 70% to about 80%, or about 80% to about 90%.

The coating may contain an amount of group C from about 10% to about 90%, about 10% to about 80%, about 10% to about 70%, about 10% to about 60%, about 10% to about 50%, about 10% to about 40%, about 10% to about 30%, about 10% to about 20%, about 20% to about 90%, about 20% to about 80%, about 20% to about 70%, about 20% to about 60%, about 20% to about 50%, about 20% to about 40%, about 20% to about 30%, about 30% to about 90%, about 30% to about 80%, about 30% to about 70%, about 30% to about 60%, about 30% to about 50%, about 30% to about 40%, about 40% to about 90%, about 40% to about 80%, about 40% to about 70%, about 40% to about 60%, about 40% to about 50%, about 50% to about 90%, about 50% to about 80% about 50% to about 70%, about 50% to about 60%, about 60% to about 90%, about 60% to about 80%, about 60% to about 70%, about 70% to about 90%, about 70% to about 80%, or about 80% to about 90%.

The monosaccharides that form the lower molecular weight carbohydrate polymers may be classified based on the number of carbon atoms. Examples of suitable monosaccharides are glucose, galactose, fructose, arabinose, xylose, mannose and rhamnose. In some embodiments, the monosaccharides are selected from glucose and fructose. The lower molecular weight carbohydrate polymers may be made of a single type of monomer. For example, the lower molecular weight carbohydrate polymers may be formed from a single fructose moiety linked to n monomers, where n is selected from 1 to 10. Alternatively lower molecular weight carbohydrate polymers may be formed from a variety of monomers. For example, the lower molecular weight carbohydrate polymers may be formed from a single fructose moiety linked to n monomers, where n is selected from 1 to 9 and may include at least one terminating glucosyl moiety.

The lower molecular weight carbohydrate polymers may be obtained by hydrolyzing or molecularly rearranging starches, fibers, or gums. Examples include commercially available ingredients like Fibersol (ADM), Promitor (Tate & Lyle), Hydrolyzed guar gum (Taiyo) etc. The hydrolysis and molecular rearrangement enables higher solubility levels along with reasonable adhesion to food substrates that can reduce the fat pick-up during frying.

A non-limiting example of the lower molecular weight carbohydrate polymers is [X-Y]ₙ, where n is a number selected from 1 to 5, where X and Y are not the same monosaccharide, and the lower molecular weight carbohydrate polymers may terminate with a monomer matching X, Y, or neither. Another example of the lower molecular weight carbohydrate polymers is [X-X]ₙ-[Y-Y]ₘ, where n is a number selected from 0 to 5 and m is a number selected from 0 to 5, so long as the total monomer length does not exceed 10 linked-monomers, X and Y are not the same monosaccharide, and the lower molecular weight carbohydrate polymers may terminate with a monomer matching X, Y, or neither. Another non-limiting example of the lower molecular weight carbohydrate polymers is [X-Y-X]ₙ, where n is a number selected from 1 to 3, where X and Y are not the same monosaccharide, and where the lower molecular weight carbohydrate polymers may terminate with a monomer matching X, Y, or neither. Another non-limiting example of the lower molecular weight carbohydrate polymers is [X-Y-Z]ₙ, where n is a number selected from 1 to 3, where X, Y, and Z are not the same monosaccharide, and where the lower molecular weight carbohydrate polymers may terminate with a monomer matching X, Y, Z or neither. Other non-limiting examples of a lower molecular weight carbohydrate polymers are [X-Y-Y-X]ₙ, [X-X-Y-X]ₙ, [X-Y-X-X]ₙ, [X-X-X-Y]ₙ, or [Y-X-X-X]ₙ, where n is a number selected from 1 or 2, and the lower molecular weight carbohydrate polymers may terminate with a least one monosaccharide that matches, X, Y, or neither, as long as the lower molecular weight carbohydrate polymer does not exceed 10 linked-monomers. Additionally, the lower molecular weight carbohydrate polymers may be formed from 2 to 10 linked monomers and the monomers are composed of one type of monosaccharide, two types of monosaccharides, three types of monosaccharides, four types of monosaccharides, five types of monosaccharides, six types of monosaccharides, seven types of monosaccharides, eight types of monosaccharides, nine types of monosaccharides, or ten types of monosaccharides. For example, a lower molecular weight carbohydrate polymer may be formed from 2 to 10 linked fructose monosaccharides. Alternatively, the lower molecular weight carbohydrate polymer may be formed from 2 to 10 linked monomers including fructose and glucose. In some embodiments, the lower molecular weight carbohydrate polymer may be formed from 2 to 10 linked monomers including fructose, glucose and galactose.

Further, the lower molecular weight carbohydrate polymers present in the coating may be a homogenous mixture, such that all the lower molecular weight carbohydrate polymers are the same length and formed from the same monomers. Alternatively, the lower molecular weight carbohydrate polymers present in the coating may be a heterogeneous mixture such that the lower molecular weight carbohydrate polymers have a range of lengths from 2 to 10 linked monomers and/or are formed from different types of monomers. For example, the lower molecular weight carbohydrate polymers may comprise group A, a mixture of group A and group B, a mixture of group B and group C, or a mixture of group A, group B, and group C. In some embodiments, the coating includes an amount of (A) lower molecular weight carbohydrate polymers formed from 2 to 5 linked monosaccharides and an amount of (B) lower molecular weight carbohydrate polymers formed from 6 to 7 linked monosaccharides so that the mixture may contain such a ratio of (A) to (B) of about 5:1 to about 1:5.

The lower molecular weight carbohydrate polymers may be selected from one or more of fructo-oligosaccharide, galacto-oligosaccharide, gluco-oligosaccharide, or xylo-oligosaccharide. As used herein, the “fructo-oligosaccharide” or “FOS” or “Sc-FOS” is defined as GFₙ where n<5, G is gluco-oligosaccharide, and F is a fructo-oligosaccharide. The lower molecular weight carbohydrate polymers may be formed from about 10% to about 90%, about 20% to about 80%, about 30% to about 70%, about 40% to about 60%, or about 50% fructose. In some embodiments, the lower molecular weight carbohydrate polymers are formed from about 10% to about 90%, about 20% to about 80%, about 30% to about 70%, about 40% to about 60%, or about 50% glucose.

The lower molecular weight carbohydrate polymers may be present in the coating from about 5 wt. % to about 80 wt. % of the coating. In some embodiments, the coating comprises between about 5 wt. % to about 30 wt. %, about 20 wt. % to about 40 wt. %, about 30 wt. % to about 50 wt. %, about 40 wt. % to about 60 wt. %, about 50 wt. % to about 70 wt. %, about 60 wt. % to about 80 wt. %, about 10 wt. % to 20 wt. %, about 20 wt. % to about 30 wt. %, about 30 wt. % to about 40 wt. %, about 40 wt. % to about 50 wt. %, about 50 wt. % to about 60 wt. %, about 60 wt. % to about 70 wt. %, about 70 wt. % to about 80 wt. %, about 10 wt. % to about 50 wt. %, about 20 wt. % to about 60 wt. %, about 30 wt. % to about 70 wt. %, about 40 wt. % to about 80 wt. %, about 20 wt. % to about 50 wt. %, about 30 wt. % to about 60 wt. %, about 40 wt. % to about 70 wt. %, about 25 wt. % to about 75 wt. %, about 25 wt. % to about 50 wt. %, or about 50 wt. % to about 75 wt. %. The coating may contain about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % lower molecular weight carbohydrate polymers.

### Poly-dextrose

As noted above, in some embodiments, the coating may comprise poly-dextrose. Poly-dextrose may be prepared by vacuum thermal polymerization of glucose, using sorbitol and an approved food acid as a catalyst. Random polymerization and branching yield various types of glycosidic bonds in the structure (1,6 bonds predominate).

The coating may contain an amount of poly-dextrose between about 10 wt. % to about 30 wt. %, about 20 wt. % to about 40 wt. %, about 30 wt. % to about 50 wt. %, about 40 wt. % to about 60 wt. %, about 50 wt. % to about 70 wt. %, about 60 wt. % to about 80 wt. %, about 10 wt. % to 20 wt. %, about 20 wt. % to about 30 wt. %, about 30 wt. % to about 40 wt. %, about 40 wt. % to about 50 wt. %, about 50 wt. % to about 60 wt. %, about 60 wt. % to about 70 wt. %, about 70 wt. % to about 80 wt. %, about 10 wt. % to about 50 wt. %, about 20 wt. % to about 60 wt. %, about 30 wt. % to about 70 wt. %, about 40 wt. % to about 80 wt. %, about 20 wt. % to about 50 wt. %, about 30 wt. % to about 60 wt. %, about 40 wt. % to about 70 wt. %, about 25 wt. % to about 75 wt. %, about 25 wt. % to about 50 wt. %, or about 50 wt. % to about 75 wt. %. The coating may contain about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, or about 90 wt. % poly-dextrose.

### Water

Water may be present in any of the coating embodiments between about 10 wt. % to about 90 wt. %, about 20 wt. % to about 80 wt. %, about 30 wt. % to about 70 wt. %, about 10 wt. % to about 40 wt. %, about 10 wt. % to about 30 wt. %, about 10 wt. % to about 20 wt. %, about 20 wt. % to about 70 wt. %, about 20 wt. % to about 60 wt. %, about 20 wt. % to about 50 wt. %, about 20 wt. % to about 40 wt. %, about 20 wt. % to about 30 wt. %, about 30 wt. % to about 90 wt. %, about 30 wt. % to about 80 wt. %, about 30 wt. % to about 70 wt. %, about 30 wt. % to about 60 wt. %, about 30 wt. % to about 50 wt. %, about 30 wt. % to about 40 wt. %, about 40 wt. % to about 90 wt. %, about 40 wt. % to about 80 wt. %, about 40 wt. % to about 70 wt. %, about 40 wt. % to about 60 wt. %, about 40 wt. % to about 50 wt. %, about 50 wt. % to about 90 wt. %, about 50 wt. % to about 80 wt. % about 50 wt. % to about 70 wt. %, about 50 wt. % to about 60 wt. %, or about 60 wt. % to about 80 wt. % water. The amount of water may impact, in part, the viscosity of the coating, which has an impact on the application process discussed further in the methods below.

The amount of water may be adjusted to control the viscosity of the coating prior to contacting the plant-based substrate. The coating may have a viscosity of between 1 cP to about 2000 cP at 60° F.-125 F. The viscosity may be adjusted based on the application process used to contact the plant-based substrate with the coating and the desired thickness and uniformity of the coating. For example, the coating may have a viscosity at about 60° F. to about 120° F. between about 1 cP-250 cP, about 250 cP to about 500 cP, about 300 cP to about 550 cP, about 350 cP to about 600 cP, about 400 cP to about 650 cP, about 450 cP to about 700 cP, about 500 cP to about 750 cP, about 550 cP to about 800 cP, about 600 cP to about 850 cP, about 650 cP to about 900 cP, about 700 cP to about 950 cP, about 750 cP to about 1000 cP, about 800 cP to about 1050 cP, or about 1100 cP to about 2000 cP. Further the viscosity of the coating may range from about 1100 cP to about 6000 cP, about 1100 cP to about 3000 cP, about 1150 cP to about 6000 cP, about 1200 cP to about 6000 cP, about 1250 cP to about 6000 cP, about 1300 cP to about 6000 cP, about 1350 cP to about 6000 cP, about 1400 cP to about 6000 cP, about 1450 cP to about 6000 cP, about 1500 cP to about 6000 cP, about 1550 cP to about 6000 cP, about 1600 cP to about 6000 cP, about 1650 cP to about 6000 cP, about 1700 cP to about 6000 cP, about 1750 cP to about 6000 cP, about 1800 cP to about 6000 cP, about 1850 cP to about 6000 cP, about 1900 cP to about 6000 cP, about 1950 cP to about 6000 cP, or about 2000 cP to about 6000 cP. In some embodiments, the viscosity may be at least 1000 cP, at least 1500 cP, at least 2000 cP, at least 2500 cP, at least 3000 cP, at least 3500 cP, at least 4000 cP, at least 4500 cP, at least 5000 cP, at least 5500 cP, or at least 6000 cP. Further, the coating may have a viscosity of about 1000 cP to about 3000 cP, about 2000 cP to about 4000 cP, or about 3000 cP to about 6000 cP.

Those of ordinary skill in the art will appreciate that the viscosity may be impacted by the temperature and concentration of the coating solution. The resulting reduction of oil-uptake may be impacted by the amount of coating adhered to the surface plant-based substrate. Accordingly, at a given temperature, when the coating solution has a higher viscosity, less coating solution may need to be applied to achieve acceptable adhesion. Similarly, when the coating solution has a lower viscosity, a greater amount to achieve acceptable adhesion.

When the coating comprises lower molecular weight carbohydrate polymers, poly-dextrose, and water, the lower molecular weight carbohydrate polymers may form between about 5 wt. % to about 90 wt. % of the coating, the poly-dextrose may form between 5 wt. % to about 90 wt. % of the coating, and the remaining balance is water.

The coating may have an acidic pH. For example the pH may be about 2 to about 5, about 2 to about 4, about 2 to about 3, about 3 to about 5, about 3 to about 4, or about 3. Without being limited by any particular theory, an acidic coating may help mitigate or reduce browning reactions from residual free sugars or reducing ends in the lower molecular weight carbohydrate polymers.

In any of the above-described embodiments, the coating may include additional water soluble components such as various hydrocolloids, dextrins, instant starches, flavoring, coloring, proteins, salt, fiber, or taste enhancers. For example, the additional water soluble components may be selected from include Dextrins, Methyl Cellulose, Hydroxy Propyl Methyl Cellulose, and instant starches. Further, the coating may include an additional fiber selected from a group of water soluble fibers like acacia gum, inulin, pectin, beta-glucan and arabinoxylan. In some embodiments, the additional component is not inulin and/or corn syrup. As used herein, “inulin” refers to a chain of repetitive fructosyl moieties terminated with a glucosyl moiety linked by β(2,1) bonds, and having a degree of polymerization (DP) of 10 or greater, or ranging from 10 to 60 linked monomers.

The coating may be applied in any suitable manner and may be accomplished using a variety of methods and the method of application is not intended to limit the disclosure. For example, the coating may be applied using a continuous belt coating device, a conventional pan, potato slice washer flume or a rotating drum coating device. Alternatively, the plant-based substrate may be dipped into the coating or passed through a glaze curtain. The application step may be configured to uniformly coat the individual plant-based substrate pieces in a manner to avoid agglomeration or sticking of pieces to each other.

When contacting the plant-based substrate with the coating (i.e., when the coating is applied to the plant-based substrate), the coating may be in a state that reduces the potential for microorganism growth. For example, the coating may be at a temperature that is less than about 30° C. Alternatively the coating solution may be kept at temperature of between about 30° C. to about 50° C. at acidic pH of 4.6 or below to mitigate microbial concerns. Coating temperatures of about 30 to about 50° C. could be used to control viscosity of coating solution to modulate level of pick-up on the substrate. Further, the temperature of the coating is such that the coating is in a liquid state.

In any of the above embodiments, the coating may be applied to the outer surface of the plant-based substrate to provide a coating thickness from about 1 nm to about 1000 nm, about 10 nm to about 1000 nm, about 20 nm to about 1000 nm, about 30 nm to about 1000 nm, about 40 nm to about 1000 nm, about 50 nm to about 1000 nm, about 60 nm to about 1000 nm, about 70 nm to about 1000 nm, 80 nm to about 1000 nm, 90 nm to about 1000 nm, about 100 nm to about 1000 nm, about 150 nm to about 1000 nm about 200 nm to about 1000 nm, about 250 nm to about 1000 nm, about 300 nm to about 1000 nm, about 350 nm to about 1000 nm, about 400 nm to about 1000 nm, about 450 nm to about 1000 nm, about 500 nm to about 1000 nm, about 550 nm to about 1000 nm, about 600 nm to about 1000 nm, about 650 nm to about 1000 nm, about 700 nm to about 1000 nm, about 750 nm to about 1000 nm, about 800 nm to about 1000 nm, about 850 nm to about 1000 nm, about 900 nm to about 1000 nm, about 950 nm to about 1000 nm, about 100 nm to about 500 nm, about 100 nm to about 900 nm, about 200 nm, to about 800 nm, about 200 nm to about 700 nm, about 200 nm to about 600 nm, about 200 nm to about 500 nm, about 300 nm to about 700 nm, about 400 nm to about 600 nm, about 500 nm to about 900 nm, or about 200 nm to about 800 nm. In some embodiments, the coating may be applied to the plant-based substrate at a thickness of about 1000 nm to about 1,000,000 nm (i.e., 1 mm), about 1000 nm to about 500,000 nm, about 2000 nm to about 600,000 nm, about 3000 nm to about 700,000 nm, about 1000 nm to about 100,000 nm, about 50,000 nm to about 150,000 nm, about 100,000 nm to about 200,000 nm, about 150,000 nm to about 250,000 nm, about 200,000 nm to about 300,000 nm, about 250,000 nm to about 350,000 nm, about 300,000 nm to about 400,000 nm, about 350,000 nm to about 450,000 nm, about 400,000 nm to about 500,000 nm, about 450,000 nm to about 550,000 nm, about 500,000 to about 600,000 nm, about 550,000 nm to about 650,000 nm, about 600,000 nm to about 700,000 nm, about 650,000 nm to about 750,000 nm, about 700,000 nm to about 800,000 nm, about 750,000 nm to about 850,000 nm, about 800,000 nm to about 900,000 nm, about 850,000 nm to about 950,000 nm, or about 900,000 nm to about 1,000,000 nm.

The amount of coating present on (or applied to) the surface of the plant-based substrate may be controlled based on the amount of pick-up. In some embodiments, the pick-up is the amount of coating present per 100 lbs of substrate. In other words, the coating pick-up may be defined as the weight of the coating divided by the weight of the substrate after the coating has been applied. The coating pick-up may be measured in any suitable manner as known in the art. For example, if all the plant substrate pieces are generally the same size, the weight of an individual piece could be measured before and after to calculate pick-up. Alternatively, average weights can be calculated for multiple slices of substrates and then by measuring weights before and after. In some embodiments, the pick-up % may range from about 0.1% to about 30%.

Conventional heating and cooling devices, such as conventional fryers, fryer/coolers, baking ovens, rotary drum dryers, and multi-pass drier/coolers may be employed to fry, cool, and/or dry the coated substrate. Fryers equipped with agitators, or stirring paddles may be employed to prevent sticking of the individual coated substrates during frying. The fryers may be equipped with product submersion means for continued, complete, more rapid frying.

Frying temperatures and times may range from about 280° F. to about 410° F. for about 5 seconds to about 20 minutes. The temperature of the oil during frying is not intended to be limiting. The fried-snack may be further processed after frying including further processing steps of removing excess oil and/or drying.

As noted above, once the coated substrate is fried, a shell is created. Without being limited by any particular theory, the shell acts as a barrier to surface oil on the plant-based substrate after it exits the fryer, preventing or inhibiting absorption of the oil into the pores of plant-based substrate as it cools. The appearance of the coated plant-based substrate may differ depending on the food substrate. In substrates with high levels of free amino acids (e.g. potatoes) the color may be darker as a result of the browning and caramelization reactions due to high free sugar content of the coatings. In addition, the resulting fried-snack may have a denser texture as compared to the same fried-snack without the applied coating.

### The Fried-Snack

A fried-snack is disclosed comprising a plant-based substrate that is transformed to a low-moisture substrate by cooking and, optionally, dehydration. The coated plant-based substrate, once transformed into a low-moisture substrate, includes an outer shell. For example, in potato slices the washing of slices removes some surface starch and thus the exterior surface is expected to be covered with some or most of the coated material. When applied to a plant-based substrate and fried, the wet coating transforms into a dry outer shell and is capable of inhibiting oil uptake post-frying.

It is theorized that the wet coating, due to its low molecular weight, adheres to the surface of the plant-based substrate and fills the cells of the plant-based substrate (e.g., in the case of a sliced potato) and/or forms a layer (e.g., in the case of baked tortillas before frying). During frying, water evaporates from the plant-based substrate forming a low-moisture substrate and the shell, resulting in the fried-snack. As the fried-snack exits the fryer, both the plant-based substrate and shell have reduced moisture content. As the fried-snacks exit the fryer they drag the oil, which is located on the fried-snack's surface. When the disclosed coating is present on the surface prior to frying, the coating prevents or inhibits the oil from entering into the pores of the plant-based substrate so that the oil drains back into the fryer as the fried-snacks come out of the fryer resulting in lower oil content present on the fried-snack. In contrast, when an uncoated fried-snack cools, the condensation of steam (as there is still some moisture in the substrate immediately after frying) creates a vacuum in the pores of the plant-based substrate that draws oil on the surface into the pores.

The shell may be disposed over the entire surface area or over substantially the entire surface area of the plant-based substrate. The shell may cover about 100%, or at least about 95%, at least about 90%, at least about 85%, or at least about 80% of the outer surface of the plant-based substrate. In some embodiments, the shell is not uniformly distributed over the outer surface of the plant-based substrate. In other embodiments, the shell is uniformly distributed over the outer surface of the plant-based substrate.

The thickness of shell on the outer surface of the plant-based substrate may range from about 1 nm to about 1000 nm, about 10 nm to about 1000 nm, about 20 nm to about 1000 nm, about 30 nm to about 1000 nm, about 40 nm to about 1000 nm, about 50 nm to about 1000 nm, about 60 nm to about 1000 nm, about 70 nm to about 1000 nm, 80 nm to about 1000 nm, 90 nm to about 1000 nm, about 100 nm to about 1000 nm, about 150 nm to about 1000 nm about 200 nm to about 1000 nm, about 250 nm to about 1000 nm, about 300 nm to about 1000 nm, about 350 nm to about 1000 nm, about 400 nm to about 1000 nm, about 450 nm to about 1000 nm, about 500 nm to about 1000 nm, about 550 nm to about 1000 nm, about 600 nm to about 1000 nm, about 650 nm to about 1000 nm, about 700 nm to about 1000 nm, about 750 nm to about 1000 nm, about 800 nm to about 1000 nm, about 850 nm to about 1000 nm, about 900 nm to about 1000 nm, about 950 nm to about 1000 nm, about 100 nm to about 500 nm, about 100 nm to about 900 nm, about 200 nm, to about 800 nm, about 200 nm to about 700 nm, about 200 nm to about 600 nm, about 200 nm to about 500 nm, about 300 nm to about 700 nm, about 400 nm to about 600 nm, about 500 nm to about 900 nm, or about 200 nm to about 800 nm. In some embodiments, the shell may have a thickness of about 1000 nm to about 100,000 nm (i.e., 100 microns), about 1000 nm to about 50,000 nm, about 2000 nm to about 60,000 nm, about 3000 nm to about 70,000 nm, about 1000 nm to about 10,000 nm, about 5,000 nm to about 15,000 nm, about 10,000 nm to about 20,000 nm, about 15,000 nm to about 25,000 nm, about 20,000 nm to about 30,000 nm, about 25,000 nm to about 35,000 nm, about 30,000 nm to about 40,000 nm, about 35,000 nm to about 45,000 nm, about 40,000 nm to about 50,000 nm, about 45,000 nm to about 55,000 nm, about 50,000 to about 60,000 nm, about 55,000 nm to about 65,000 nm, about 60,000 nm to about 70,000 nm, about 65,000 nm to about 75,000 nm, about 70,000 nm to about 80,000 nm, about 75,000 nm to about 85,000 nm, about 80,000 nm to about 90,000 nm, about 85,000 nm to about 95,000 nm, or about 90,000 nm to about 100,000 nm.

The shell may comprise at least about 0.1 wt. % of the fried snack or up to about 50 wt. % of the fried snack. The shell may form between about 0.1 wt. % to about 25 wt. %, about 0.5 wt. % to about 20 wt. %, about 1 wt. % to about 15 wt. %, about 1.5 wt. % to about 10 wt. %, or about 2 wt. % to about 5 wt. % of the fried snack. In some embodiments, the shell may form about 0.01 wt. % to about 1 wt. %, about 0.05 wt. % to about 1 wt. %, about 0.1 wt. % to about 1 wt. %, or about 0.5 wt. % to about 1 wt. % of the fried snack. In some embodiments, the shell may form about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, or about 42 wt. % of the fried snack. In some embodiments, the shell may form about 0.01 wt. %, about 0.05 wt. %, about 0.1 wt. %, about 0.5 wt. %, about 1. wt. %, about 1.5 wt. %, or about 2 wt. % of the fried snack.

In some embodiments, the fried-snack may have a moisture content ranging from about 0.5 wt. % to about 3 wt. %.

The fried snack having the disclosed shell may exhibit a reduction in oil uptake of about 50%, about 45%, about 40%, about 35%, about 30%, about 25%, about 20%, about 15%, about 10%, or about 5% compared to an identical fried-snack prepared without the step of coating with the disclosed coatings. The reduction in oil uptake may be between about 50% to about 5%, about 40% to about 5%, about 30% to about 5%, about 20% to about 5% or about 10% to about 5%, compared to the identical fried-snack prepared without the step of coating with the disclosed coatings.

### EXAMPLES AND METHODOLOGY

### Example 1: Coating Preparation

A first coating was prepared containing 91 parts poly-dextrose, 9 parts short chain fructo-oligosaccharides (Sc-FOS), and water. The Sc-FOS may be purchased from a commercial vendor and sold under the brand name NUTRAFLORA. This first coating (denoted as 91:9 polydextrose:FOS) contained about 30 wt. % water mixed with about 70 wt. % polydextrose:Sc-FOS.

A second coating was prepared containing only Sc-FOS and water. This second coating comprised about 30 wt. % water mixed with about 70 wt. % FOS.

### Example 2: Coating Application and Frying

A first batch of sliced potato pieces weighing in total about 681 grams was coated with about 200 grams of the first coating. A second batch of potato slices weighing in total about 681 grams was coated with about 200 grams of the second coating solution. Each coating was applied to all of the potato pieces in each respective batch in a manner to evenly coat each potato piece. Next, each batch was separately fried in oil. The initial oil temperature was maintained at approximately 360° F. with hand stirring in a dunker for a total frying time of about 3 min to about 3.5 min

### Example 3: Post-Frying Analysis

After frying, each batch described in Example 2 was analyzed to measure the amount of oil uptake. The oil uptake of each batch was compared to a control batch formed from sliced potato pieces weighing in total about 681 grams with no applied coating and fried in the same manner as each batch described in Example 2. The oil-uptake was measured using quantitative NMR. For example, a commercially available OXFORD INSTRUMENTS MQC or MQC+NMR can be used to quantify triglycerides in the fried potato pieces. Using NMR to quantify triglycerides is known in the industry.

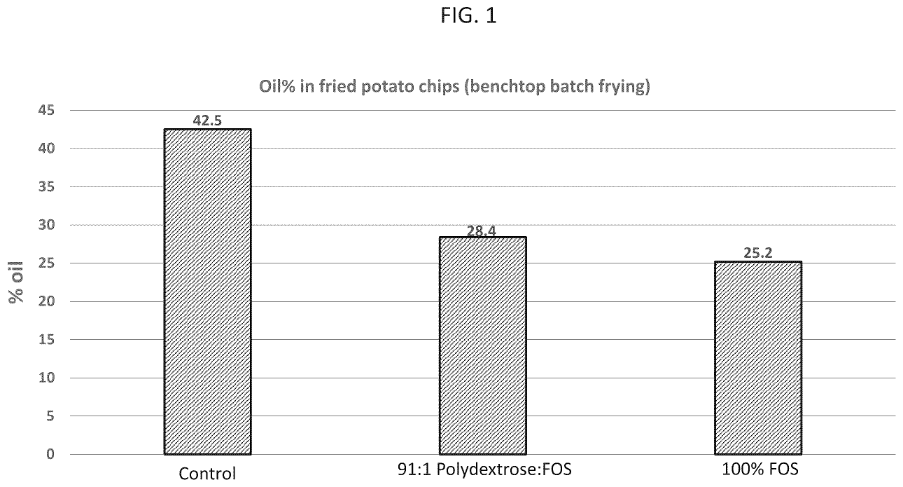

When the nucleus of hydrogen molecules in the fat triglycerides are irradiated with radio waves of a certain frequency, the emitted energy's intensity can be measured correlating to the amount of triglycerides in the fried potato pieces. The oil content could be measured using other industry standard methods such as wet chemistry methods like AOAC 922.06. FIG. 1 shows a graphical representation of the results of the NMR analysis. The control batch contained about 42.5 wt. % oil while the first coating batch contained about 28.4 wt. % oil and the second coating batch contained about 25.2 wt. % oil. Both coated batches had a reduced oil uptake by about 33% to about 41% compared to the control batch.

While the concepts of the present disclosure are susceptible to various modifications and alternative forms, specific exemplary embodiments of the disclosure have been shown by way of example. It should be understood, however, that there is no intent to limit the concepts of the present disclosure to the particular disclosed forms; the intention is to cover all modifications, equivalents, and alternatives falling within the spirit and scope of the invention as defined by the claims. Although this disclosure refers to specific embodiments, it will be understood by those skilled in the art that various changes in form and detail may be made without departing from the subject matter set forth in the accompanying claims.

Additionally, where an embodiment is described as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

The phrase “consisting essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

The phrase “consisting of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

1. A fried-snack comprising:
a plant-based substrate having an outer surface,
a shell disposed on the outer surface of the plant-based substrate and including lower molecular weight carbohydrate polymers comprising two to ten-linked monosaccharides.

2. The fried-snack of claim 1, wherein the monosaccharides are selected from glucose, fructose, galactose, arabinose, mannose, xylose, rhamanose, or a combination thereof.

3. The fried-snack of claim 1, wherein the lower molecular weight carbohydrate polymers comprise about 50 wt. % to about 90 wt. % glucose monosaccharides and about 10 wt. % to about 50 wt. % fructose monosaccharides.

4. The fried-snack of claim 1, wherein the lower molecular weight carbohydrate polymers comprise at least 50 wt. % fructose monosaccharides.

5. The fried-snack of claim 1, wherein the lower molecular weight carbohydrate polymers comprise between about 25% to about 75% of two to five-linked monosaccharides.

6. The fried-snack of claim 1, wherein the shell thickness is between about 1 nm and about 1000 nm.

7. (canceled)

8. The fried-snack of claim 7, wherein the shell further includes at least one of acacia gum, pectin, or beta-glucan.

9. The fried-snack of claim 1, wherein the plant-based substrate is selected from potato or flour formed from a plant-based source.

10. (canceled)

11. The fried-snack of claim 1, wherein the shell does not contain corn syrup or inulin.

12. (canceled)

13. (canceled)

14. The fried-snack of claim 1, wherein the shell includes about 10 wt. % to about 90 wt. % fructo-oligosaccharide and about 10 wt. % to about 90 wt. % poly-dextrose.

15. The fried-snack of claim 1, wherein the shell comprises about 0.01 wt. % to about 30 wt. % of the fried snack.

16. (canceled)

17. (canceled)

18. (canceled)

19. A method of producing a fried snack having a reduced oil uptake upon frying comprising:
contacting a plant-based substrate with a coating formed from about 30 wt. % to about 70 wt. % lower molecular weight carbohydrate polymers having a length of 2 to 10 linked monosaccharides to form a coated substrate, and
frying the coated substrate to form a fried snack.

20. The method of claim 19, wherein the plant-based substrate is washed prior to contacting with the coating.

21. The method of claim 19, wherein the monosaccharides are selected from glucose, fructose, galactose, arabinose, mannose, xylose, rhamanose, or a combination thereof.

22. The method of claim 19, wherein the lower molecular weight carbohydrate polymers include about 30 wt. % to about 95 wt. % of 2 to 5 linked monosaccharides.

23. The method of claim 19, wherein the lower molecular weight carbohydrate polymers include about 5 wt. % to about 70 wt. % of 6 to 7 linked monosaccharides.

24. The method of claim 23, wherein the coating includes an amount of (A) lower molecular weight carbohydrate polymers formed from 2 to 5 linked monosaccharides and an amount of (B) lower molecular weight carbohydrate polymers formed from 6 to 7 linked monosaccharides, wherein a ratio of (A) to (B) is about 5:1 to about 1:5.

25. The method of claim 19, wherein there is no step of dehydrating the substrate.

26. (canceled)

27. (canceled)

28. (canceled)

29. (canceled)

30. The method of claim 9, wherein the coating comprises water, fructo-oligosaccharide, and poly-dextrose.

31. The method of claim 30, wherein the coating comprises about 30 wt. % to about 95 wt. % of water.

32. The method of claim 31, wherein the coating comprises about 5 wt. % to about 70 wt. % of fructo-oligosaccharide.

33. The method of claim 32, wherein the coating comprises about 0.5 wt. % to about 60 wt. % of poly-dextrose.

34. The method of claim 19, wherein the fried snack has a reduced oil uptake between about 5% to about 50% compared to a fried snack produced without the coating.
